(19) United States
(12) Patent Application Publication
(10) Pub. No.: US 2018/0096310 A1
(43) Pub. Date: Apr. 5, 2018

(54) Activity Performance Enhancement System

(71) Applicant: equipt LLC, Fort Collins, CO (US)

(72) Inventors: Aaron Skalicky, Fort Collins, CO (US); Larry Salmen, Fort Collins, CO (US); Paul Knight, Loveland, CO (US)

(73) Assignee: equipt LLC, Fort Collins, CO (US)

(21) Appl. No.: 15/286,322

(22) Filed: Oct. 5, 2016

(51) Int. Cl. G06Q 10/10; G06F 19/00

(52) U.S. Cl. CPC G06Q 10/1097; G06F 19/322; G06F 19/3418

(57) ABSTRACT

A computer implemented activity performance enhancement system operable to display graphical user interface including a setup menu in which a plurality of target activities can be allocated based on the age, development, or clinical status of a user and a runtime menu interactive with user to indicate performance or non-performance of each of the target activities and to calculate a cumulative performance score, automatically adjusted based on current and prior performance over a period of time, which provides a measure for allocating incentives to further induce the user to perform the plurality of target activities in conformance with scheduled time or frequency

### I. FIELD OF THE INVENTION

A computer implemented activity performance enhancement system operable to display a graphical user interface including a setup menu in which a plurality of target activities can be allocated based on the age, developmental, or clinical status of a user and a runtime menu interactive with the user to indicate performance or non-performance of each of the target activities and which calculates a cumulative performance score, automatically adjusted based on current and prior performance over a period of time, which provides a measure for allocating incentives to further induce the user to perform the plurality of target activities in conformance with a scheduled time or frequency.

### II. SUMMARY OF THE INVENTION

A broad object of the invention can be to provide an activity performance enhancement system in the form of a server and a server processor communicatively coupled to a server memory containing a computer program having computer-executable instructions which can be served in whole or in part to one or a plurality of computing devices and functions to depict a graphical user interface including a setup menu in which a first user can select a plurality of target activities based on the age, developmental, or clinical status of a second user and can further function to depict a runtime menu interactive with the second user to indicate performance or non-performance of each of the target activities and which further functions to calculate and compare performance scores against one or more pre-selected target performance thresholds to provide a measure by which incentives can be allocated or restricted to the second user to induce the second user to perform the plurality of target activities in conformance with a scheduled time or with greater frequency over consecutive opportunities to perform the plurality of target activities.

Another broad object of the invention can be to provide an activity performance enhancement system in the form of a server and a server processor communicatively coupled to a server memory containing a computer program having computer-executable instructions which can be served in whole or in part to a plurality of computing devices to depict a graphical user interface including a setup menu in which a first user can select a plurality of target activities and a runtime menu interactive with the second user to indicate performance or non-performance of each of the target activities and which further functions to calculate and compare performance scores against one or more pre-selected target performance thresholds over a period of time to provide a measure of performance or non-performance and which further functions to insert, replace or remove target activities or to bias performance scores to adjust allocation of incentives to the second user, each to induce the second user to perform a plurality of target activities in conformance with a scheduled time or with greater frequency over consecutive opportunities to perform the plurality of target activities.

Another broad object of the invention can be a method of using an activity performance enhancement system in which computer-executable instructions function to depict a first graphical user interface in a first computing device including a setup menu in which a first user interacts to enter the age status, developmental status or clinical status of a second user to obtain and select from a plurality of target activities and in which the user can further input indications of performance score bias which prompts the system to bias performance score to increase or decrease performance scores to correspondingly allocate performance incentives more or less liberally to a second user. The program can also be executed to depict a second graphical user interface to a paired second computing device in which a second user indicates performance or non-performance of each of the plurality of target activities to obtain performance incentives.

Naturally, further objects of the invention are disclosed throughout other areas of the specification, drawings, photographs, and claims.

### III. BRIEF DESCRIPTION OF THE DRAWINGS

FIG. 1 is a block diagram of a particular embodiment of the activity performance enhancement system.

FIG. 2 is a block diagram of a particular method of using the particular embodiment of the activity performance enhancement system shown in FIG. 1.

FIG. 3 is an illustration of a particular embodiment of a user interface including a setup menu which by user command allows a user to enter default settings used by the activity performance enhancement system to allocate target activities, calculate performance scores and allocate incentives to a user.

FIG. 4 is an illustration of a particular embodiment of a user interface including a setup menu which by user command allows a user to select default settings from a plurality of drop down list relating to the age status, developmental status, and clinical status of a user.

FIG. 5 is an illustration of a particular embodiment of a user interface including a setup menu which by user command allows a user to enter default settings relating to the target activities to be performed by a user in the A.M.

FIG. 6 is an illustration of a particular embodiment of a user interface including a setup menu which by user command allows a user to enter default settings relating to the target activities to be performed by a user in the P.M.

FIG. 7 is an illustration of a particular embodiment of a user interface including a setup menu which by user command allows a user to enter default settings to allocate incentives into one or more performance levels relating to the performance or non-performance of target activities by the user.

FIG. 8 is an illustration of a particular embodiment of a user interface including a setup menu which by user command allows a user to input indications of performance score bias which prompts the system to bias performance scores.

FIG. 9 is an illustration of a particular embodiment of a user interface including a runtime menu which by user command allows a user to provide an indication of performance or non-performance of target activities to be performed in the A.M.

FIG. 10 is an illustration of a particular embodiment of a user interface including a runtime menu which by user command allows a user to provide an indication of performance or non-performance of target activities to be performed in the P.M.

FIG. 11 is an illustration of a particular embodiment of a user interface including a runtime menu which by user command allows a user to validate performance or non-performance of target activities performed in the A.M. and in the P.M.

FIG. 12 is an illustration of a particular embodiment of a user interface including a runtime menu which allows a user to view the performance level status relating to indication of performance or non-performance of the plurality of activities entered into the setup menu shown in FIGS. 5 and 6 by each of a plurality of other users.

FIG. 13 is an illustration of a particular embodiment of a user interface including an edit menu which by user command allows a user to edit the settings entered into the setup menu shown in FIGS. 3 through 8 based on a user's past performance or non-performance of target activities.

### IV. DETAILED DESCRIPTION OF THE INVENTION

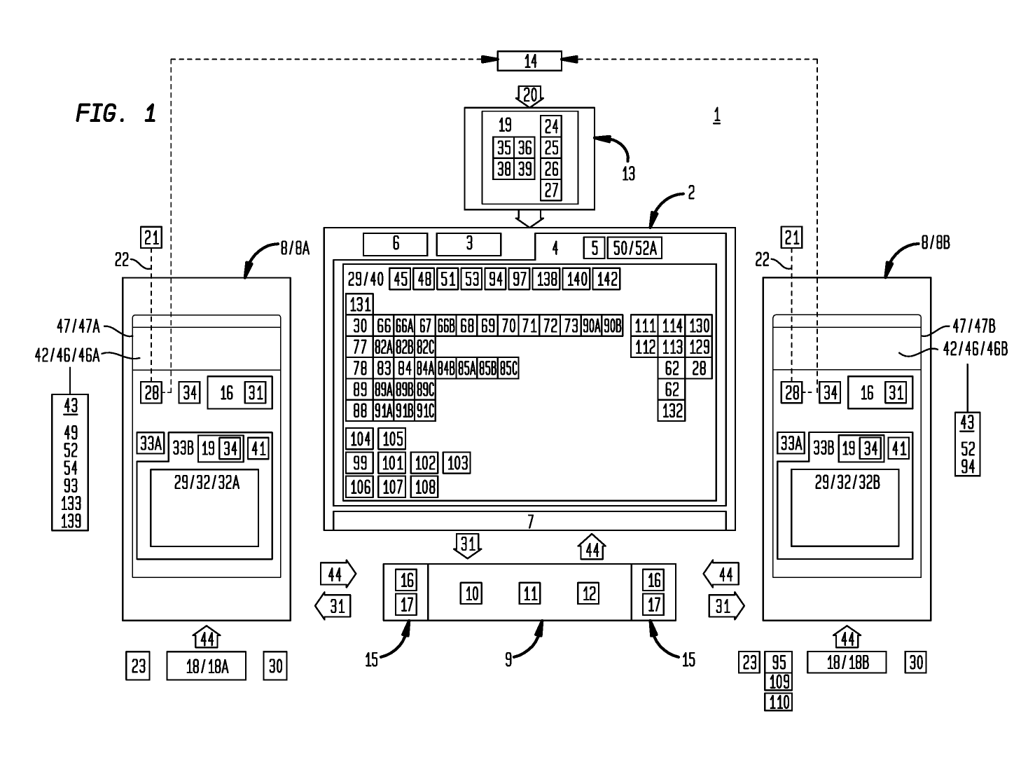

Now referring primarily to FIG. 1, which illustrates a computer-based activity performance enhancement system (1) (also referred to as the “system”) which may be distributed on one or more servers (2), each having one or more of a server processor (3), a server memory (4), a server operating system (5), a server input/output interface (6), and a server network interface (7) operably coupled to a plurality of computing devices (8) by a public network (9), such as the Internet (10), a cellular-based wireless network(s) (11), or a local network (12). The system (1) can, but need not necessarily, further include a location identification server (13) operably coupled to a global positioning system (“GPS”) (14) and the public network (9), cellular-based wireless network (11), or local network (12) (also individually or collectively referred to as a “network (9)”).

The network (9) supports a plurality of communication resources (15) (along with other communication resources made available in the future) to afford as illustrative examples: recording, transmission, or reproduction of images (whether still or moving images), sound relating to acoustical, mechanical or electrical frequencies, electronic mail, instant messaging, text messaging (such as short message service) multimedia messaging (such as multimedia message service), (also referred to as “functionalities (16)”) attributable to the execution of self-contained programs or pieces of software designed to fulfill particular purposes (also referred to as “applications” (17)), as illustrative examples: web applications, online applications, mobile applications, downloadable by a user (18) to the plurality of computing devices (8), including as illustrative examples: desktop or mobile computer devices such as personal computers, slate, tablet or pad computers, and cellular telephones or camera/cell phones, and programmable consumer electronics.

The location identification server (13) contains a global positioning program (19) capable upon execution of receiving and decoding a global positioning signal (20) generated by the GPS (14). The term “global positioning system (“GPS”) (14)”, for the purposes of this invention, means a plurality of earth-orbiting satellites (21) each transmitting a satellite positioning signal (22) continuously towards the Earth (23), that enables a coordinate location (24), including a longitude (25), a latitude (26) or altitude (27) of a global positioning signal receiver (28) on or near the surface of the Earth (23) to be accurately estimated.

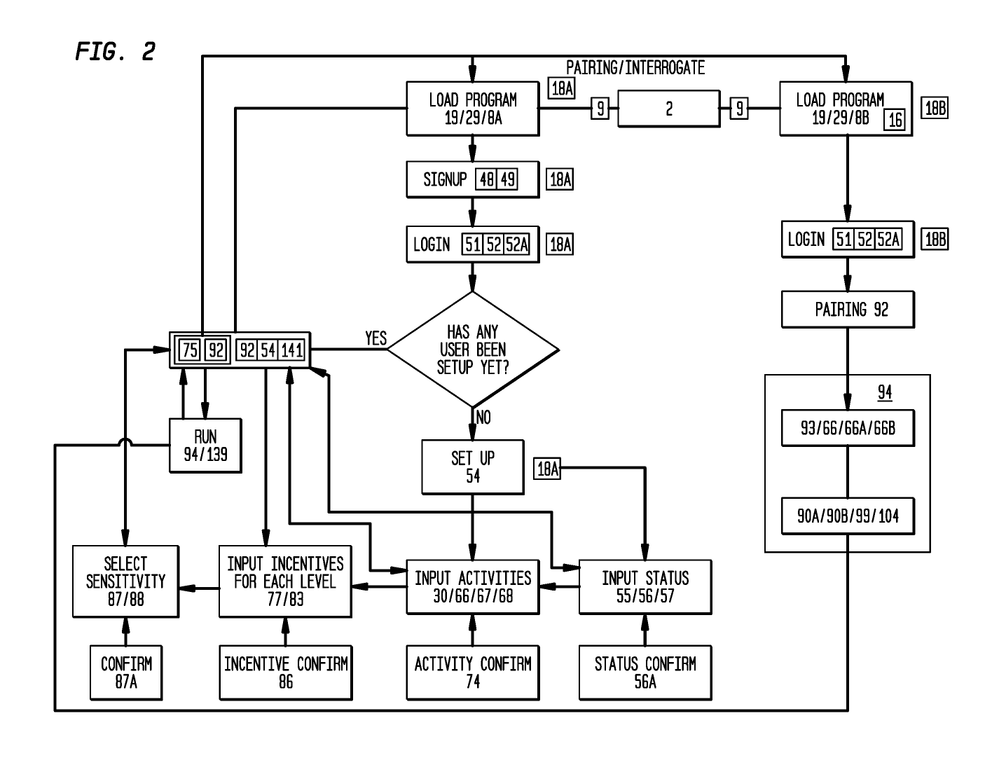

Now referring primarily to FIGS. 1 and 2, the server (2) can include a server processor (3) communicatively coupled to the server memory (4) containing an activity performance enhancement computer program (29) (also referred to as the “computer program (29)”) to monitor, reinforce and maintain performance of one or more target activities (30) of one or a plurality of users (18) of the system (1). The computer program (29) can be downloaded to one or more computing devices (8) via the network (9) from one or more servers (2) to correspondingly confer user interactive functionalities (16) in and to the one or more computer devices (8) to provide computing device content (31), as illustrative examples: Internet documents, graphics, audio, and video files, voice communication, electronic mail, instant messages, graphical games.

The computer program (29) can be downloaded in whole from the server (2) to a first computing device (8A) (having local processor (33A) communicatively coupled to a local memory element (33B)) to discretely confer all of the functions (32A) of the computer program (29) to the first computing device (8A) for use only by a first user (18A), or the computer program (29) can be downloaded in part to a first computing device (8A) for use by a first user (18A) and in part to a second computing device (8B) for use by a second user (18B) (or in whole or in part to a plurality of computing devices) to discretely confer a first portion of the functions (32A) of the computer program (29) to the first computing device (8A) and discretely confer a second portion of the functions (32B) of the computer program (29) to the second computing device (8B) (or to a plurality of computing devices (8)) for integrated or coordinated use of the first computing device (8A) by the first user (18A) and the second computing device (8B) by the second user (18B) (or a plurality of users (18)).

The computer program (29) may also be contained on and loaded to the first or second computing devices (8A)(8B) (or a plurality of computing devices (8)) from one or more of: a computer disk, universal serial bus flash drive, or other computer readable medium. The computer program (29) can operatively communicate with the server (2) over the network (9) to communicatively couple the first computing device (8A) with the server (2) to coordinate or pair operation of the first computing device (8A) with operation of a second computing device (8B). As to particular embodiments, the first computing device (8A) or the second computing device (8B) can, but need not necessarily, download the GPS program (19), which may be operatively coupled to the location identification server (13). As to embodiments of the first or the second computing device (8A)(8B) including GPS functions (34), the computer program (29) can cause retrieval or receive a coordinate location (24) of the first or second computing device (8A)(8B) from the location identification server (13). The computer program (29) can further receive a coordinate location (24) of the first computing device (8A) or the second computing device (8B), which may include a current location (35) at a current time (36) or expected location (38) at a future time (39). The computer program (29) can communicate the coordinate location (24) of the first or second computing device (8A)(8B) to the server (2).

While embodiments of the computer program (29) are described in the general context of computer-executable instructions such as program modules (40) which utilize routines, programs, objects, components, data structures, or the like, to perform particular functions or tasks or implement particular abstract data types, it is not intended that any embodiments be limited to a particular set of computer-executable instructions or protocols.

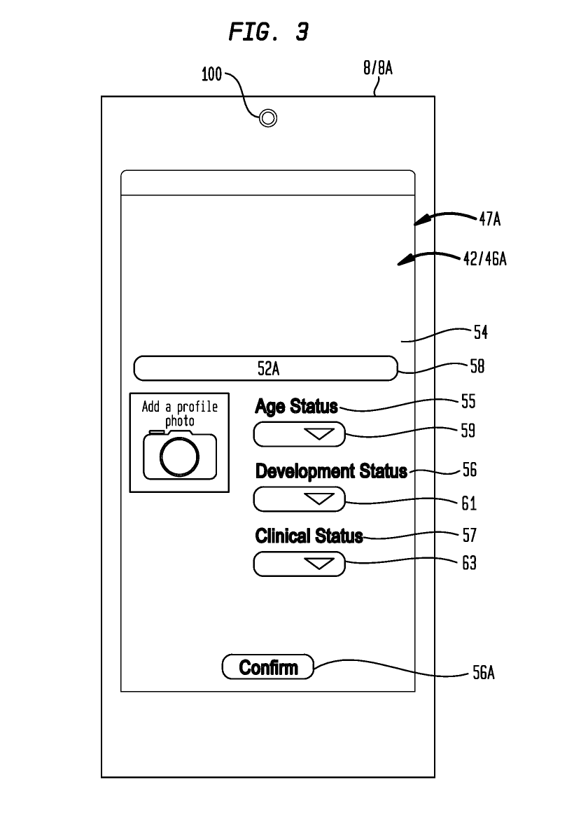

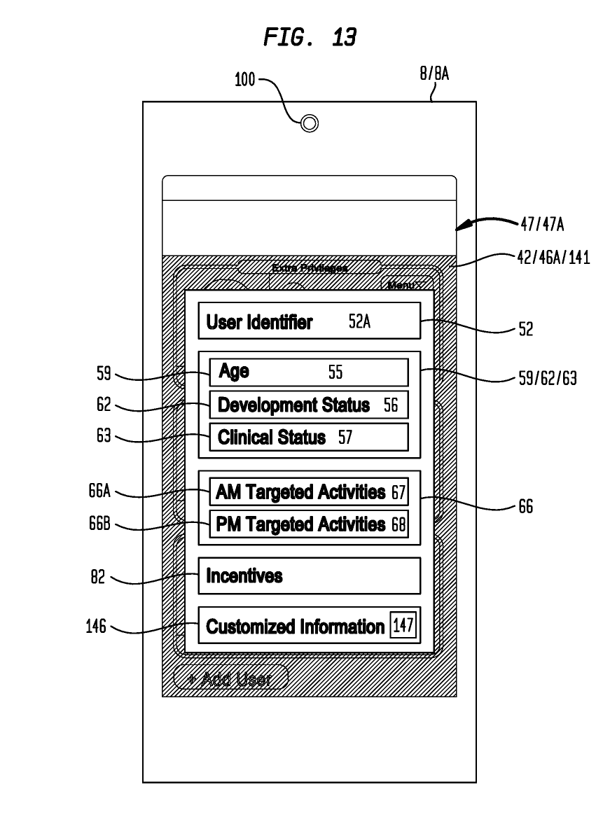

Again referring primarily to FIG. 1, each of the one or more computing devices (8) can, but need not necessarily, include an Internet browser (41) (also referred to as a “browser”), as illustrative examples: Microsoft's INTERNET EXPLORER®, GOOGLE CHROME®, MOZILLA®, FIREFOX®, which functions to download and render computing device content (31) formatted in “hypertext markup language” (HTML). In this environment, the one or more servers (2) can contain the computer program (29) which implements the most significant portions of one or more graphical user interface(s) (42) including one or more menus (43) including a combination of text and symbols to represent options selectable by user command (44) to execute the functions (32) of the computer program (29). As to these embodiments, the one or more computing devices (8) can use the Internet browser (41) to depict downloaded computing device content (31) and to relay selected user commands (44) back to the one or more servers (2). The one or more servers (2) can respond by formatting new menus (43) for the respective graphical user interfaces (42) (as shown in the illustrative examples of FIGS. 3 through 13 and further described below).

Again referring primarily to FIG. 1, in other embodiments, the one or more servers (2) can be used primarily as sources of computing device content (31), with primary responsibility for implementing the graphical user interface (42) being placed upon each of the one or more computing devices (8). As to these embodiments, each of the one or more computing devices (8) can run the appropriate portions of the computer program (29) implementing the corresponding functions (32) including but not limited to the depiction of the graphical user interfaces (42).

Now referring primarily to FIG. 1, the computer program (29) in part includes a user interface module (45) executable to generate a user interface (42) which can, but need not necessarily, be a graphical user interface (46) depicted on the computing device display surface (47) (a first computing device display surface (47A) or a second computing device display surface (47B)) of a computing device (8) (a first computing device (8A) or a second computing device (8B)) which allows a user (18) (or a first or second user (18A)(18B) or a plurality of users (18)) to execute by user command (44) one or more functions (32) of the computer program (29). The user (18) interacts with the user interface (42) to execute one or more functions (32) of the computer program (29) by user command (44), which as illustrative examples, can include: selection of one or more control icon(s), entry of text into one or more fillable fields, voice command, keyboard stroke, mouse button point and click, touch on a touch screen, or otherwise, or combinations thereof (individually and collectively referred to as a “user command”).

Now referring primarily to FIGS. 1 and 2, embodiments of the computer program (29) can, but need not necessarily, include a sign up module (48) which upon execution depicts a sign up menu (49) which by user command allows the user (18) to create an account (50) under which allows a user (18) to authenticate to the system (1) and potentially receive authorization to access resources (15) provided by or connected to the system (1) and load the computer program (29).

Now referring primarily to FIGS. 1 and 2, embodiments of the computer program (29) can, but need not necessarily, include a login module (51) which upon execution depicts a login menu (52) which by user command allows the user (18) to log in to an account (50). To log in to an account (50), a user (18) is typically required to authenticate oneself with a password or other credentials for the purposes of accounting, security, logging, and resource management. Once the user has logged on, the system (1) will often use a user identifier (52A) such as an integer to refer to them, rather than their username, through a process known as identity correlation. As one illustrative example, in Unix® systems, the username is correlated with a user identifier (52A).

Now referring primarily to FIGS. 1 through 6, embodiments of the computer program (29) can, but need not necessarily, include a setup module (53) which by user command (44) allows settings or values to be assigned to the computing program (29) or the computing device (8). Certain embodiments can, but need not necessarily, be provided with presets which provide settings or values automatically assigned by or to the computer program (29) outside of user intervention. For the sake of brevity, the particular illustrative example depicted in FIGS. 1 through 13 and further described below, include a first computing device (8A) and a second computing device (8B) having respective operation coordinated by the system (1); this not intended to preclude embodiments in which the operation of a first computing device (8A) coordinates the operation of a plurality of second computing devices (8B) in a computer administrator-computer user relationship within the system (1), or embodiments in which only one computing device (8) interacts with the resources (15) of the system (1) to have access to all of the functions (32) of the computer program (29) as shown and described by the illustrative examples without interacting with a second computing device (8B).

Now referring primarily to FIGS. 1 through 4, the setup module (53) can function to display a setup menu (54) on the display surface (47A) of the first computing device (8A) of the first user (18A) by which the first user (18A) by user command (44) inputs one or more of: a user identifier (52A), age status (55), developmental status (56), or clinical status (57) of one or more second user(s) (18B) that will correspondingly interact with one or more second computing device(s) (8B).

For the purposes of this invention the term “user identifier (52A)” means integers or characters or combination thereof unique to a user (18)(18A)(18B) which by operation of the setup module (53) can be matched to data structures of that user (18). In the illustrative example of FIGS. 1 through 6, the set up module (53) depicts a user identifier field (58) into which the user identifier (52A) can be entered. As to the illustrative example shown in the FIG. 3, the first user (18A) can be a parent and the second user (18B) can be a child and the user identifier (52A) can be associated with the data structures of that child; however, this example is not intended to preclude embodiments in which the relationship between the first user (18A) and the second user (18B) may, as illustrative examples, be: guardian and child, caretaker and adult, counselor and client, coach and athlete, or the like.

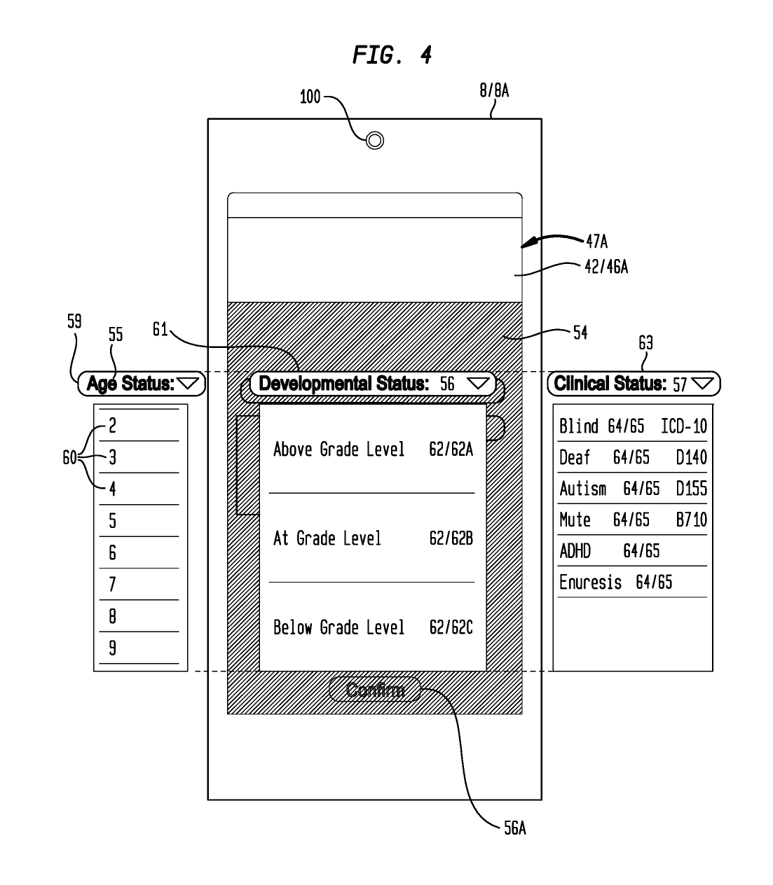

For the purposes of this invention the term “age status (55)” means the length of time that a user (8) has lived from the date of birth. As shown in the illustrative example of FIGS. 3 and 4, the setup module (53) can further function to generate an age status drop down list (59) containing selectable age indicia (60) one of which can be selected by user command (44) of the first user (18A) to input the age status (55) of the second user (18B); however, this does not preclude embodiments in which age status (55) can be selected by other types of user commands. Typically, the range of selectable age indicia (60) will be from about 2 years old to about 100 years old and in the context of a child from about 2 years old to about 18 years old.

For the purposes of this invention “development status (56)” means a determination as to whether a series or group of cognitive, physical, or behavioral abilities of a user (18) is above or below the level of average abilities of other persons of the same age status (55). As shown in the illustrative example of FIGS. 3 and 4, the setup module (53) can further function to generate a development status drop down list (61) containing selectable development status categories (62) which can be selected based on a subjective or objective evaluation by the first user (18A) of the development status (56) of the second user (18B); however, this does not preclude embodiments in which development status (56) can be selected by other types of user commands (44). As shown in the embodiment of FIG. 4, the selectable development status categories (62) for the second user (18B) (a child) can be based on a comparison of the development status (56) of the second user (18B) (a child) as being “above grade level” (62A), “at grade level” (62B), or “below grade level (62C)” in comparison to other children in the same grade level; however, the selectable development status categories (62) can be based on a comparison of the development status (56) of the second user (18B) in comparison to other classes or divisions of persons regarded as having a particular shared characteristic, as illustrative examples: intelligence, height, weight, habit.

For the purposes of this invention the term “clinical status (57)” means a determination of a condition which limits a user cognitively, physically or behaviorally. As shown in the illustrative example of FIGS. 3 and 4, the setup module (53) can further function to generate a clinical status drop down list (63) containing selectable clinical status indicia (64) as illustrative examples: autism, attention deficit/hyperactivity disorder (“ADHD”), enuresis, deaf, mute, or selectable clinical status codes (65) (for example: the codes of the International Classification of Impairments, Disabilities, and Handicaps) which can be selected based on impressions of the first user (18A) relating to the second user (18B); however, this does not preclude embodiments in which clinical status (57) can be input or selected by other types of user commands (44). As an illustrative example, the clinical status (65) of autism can be selected by the first user (18A).

The setup menu (54) can further function to depict user status confirmation icon (56A). The first user (18A) by interaction with the user status confirmation icon (74) can cause the setup module (53) to associate the age status (55), development status (56) or clinical status (57) (collectively “user status”) selected by the first user (18A) with the user identifier (52A) of the second user (18B) and to save the user status associated with the user identifier (52A) of the second user (18B) in the local memory (33B) of the first computing device (18A) or in the server memory (4) of a server (2) within the system (1).

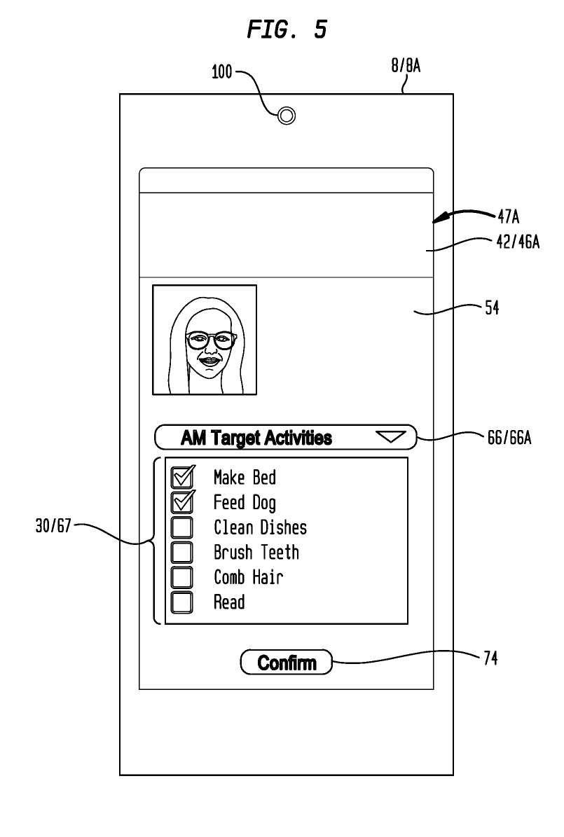

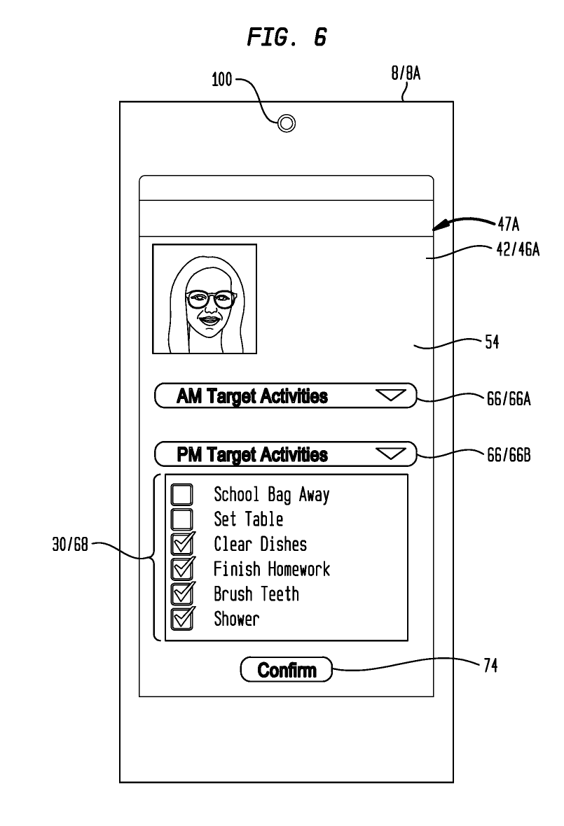

Now referring primarily to FIGS. 1 through 6, as to particular embodiments, the setup module (53) can, but need not necessarily, further function to identify one or more target activities (30) associable with the second user (18B) based upon the age status (55), development status (56) or clinical status (57), or combinations thereof, entered by user command (44) of the first user (18A) in the setup menu (54). The setup module (53) can further function to depict in the setup menu (54), a drop down list of one or more target activities (66) identified by operation of the setup module (53) as being associable with one or more of age status (55), development status (56), clinical status (57), or combination thereof, of the second user (18B) (as shown the example of FIG. 5). The first user (18A) by user command (44) in the setup menu (54) can select to input all or a subset of the one or more target activities (30) to be associated with the second user (18B); however, this does not preclude embodiments in which the one or more target activities (30) can be selected by other types of user command (44). While the illustrative setup menu (54) shown in the example of FIGS. 5 and 6, depicts a plurality of target activities (30) associable with the second user (18B); this does not preclude a greater or lesser plurality of target activities (30) which may be listed by the setup module based upon the input age status (55), development status (56) or clinical status (57) of the second user (18B). As one illustrative example, if the first user (18A) selects in the clinical status drop down list (63) the clinical status (65) of autism, the setup module (53) can function to identify one or more target activities (30) matched to the age status (55) and development status (56) of the second user (18B) and can further function to include target activities (30) associated with the clinical status (65) of autism, as illustrative examples: eye contact, personal space, inside voice, take turns, ask someone about their day, stay on topic, or combinations thereof. Again referring to the illustrative example of FIGS. 5 and 6, as to particular embodiments, the setup module (53) can function to generate a first drop down list of one or more target activities (66A) as A.M. target activities (67) (before noon) and a second drop down list of one or more target activities (66B) as P.M target activities (68) (after noon) and by further user command in the setup menu (54) A.M. target activities (67) can be selected and by further user command (44) of the first user (18A) in the set up menu (54) P.M. target activities (68) can be selected. Each of the A.M. activities (67) and the P.M. activities (68) can be associated with the second user (18B) for performance in the A.M. and the P.M. respectively.

Now referring primarily to FIGS. 1 and 5-6, as to particular embodiments, each of the more target activities (30) can each be discretely associated to one of a plurality of adaptive skill domains (69). For the purposes of this invention, the term “adaptive skills” means skills needed to function and meet the demands of the user's environment, including the skills necessary to effectively and independently take care of the user (18) and to communicate or socialize with other persons. As to particular embodiments of the invention, the one or more target activities (30) can each be allocated to one of the plurality of adaptive skill domains (69) and the setup module (53) can further function to maintain a pre-selected ratio (70) (whether by default or entered into the setup menu (54) by user command (44)) of the one or more target activities (30) selected by the first user (18A) between the plurality of adaptive skill domains (69). For example, each of the one or more target activities (30) can be allocated to one of the plurality of adaptive skill domains (69) including or consisting of: “self-care (71),” “communication (72)”, or “socialization (73)” and the pre-selected ratio (70) can, but need not necessarily, be set at 85%:10%:5% respectively. If the first user (18A), attempts to select one or more target activities (30) allocated only to the adaptive skill domain (69) of communication (72), the set up module (53) can disallow the selected target activities (30) until the first user (18A) selects other target activities (30) to satisfy the pre-selected ratio (70) of 85%:10%:5%. This illustrative example, does not preclude embodiments that allocate the one or more target activities (30) between a lesser or greater number of adaptive skill domains (69) or in which the pre-selected ratio (70) between target activities (30) is differently proportioned.

Again primarily referring to FIGS. 5 and 6, the setup menu (54) can further function to depict a target activities confirmation icon (74) associated with the selected list of target activities (66)(66A)(66B). The first user (18A) by interaction with the target activities confirmation icon (74) can cause the setup module (53) to associate the list(s) of target activities (30) selected by the first user (18A) with the user identifier (52A) of the second user (18B) and to save list(s) of one or more target activities (30)(68)(69) associated with the user identifier (52A) of the second user (18B) in the local memory (33B) of the first computing device (18A) or in the server memory (4) of a server (2) within the system (1).

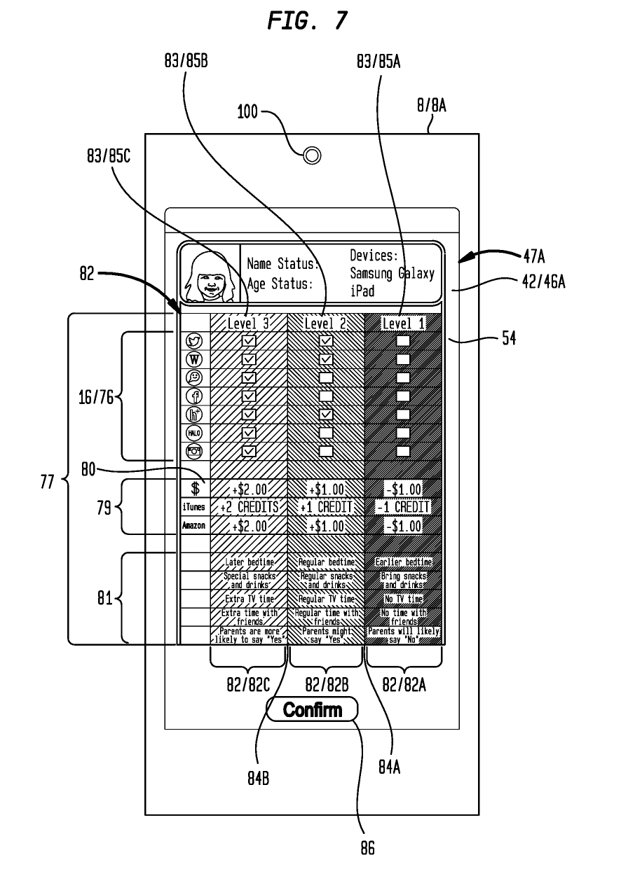

Now referring primarily to FIGS. 1-2 and 7, as to particular embodiments, the setup module (53) can, but need not necessarily, further function to interrogate (75) the second computing device (8B) of the second user (18B) to inventory the functionalities (16) (as above defined) associated with the second computing device (8B). The setup module (53) can, but need not necessarily, depict a list of functionalities (76) associated with the one or more second computing devices (18B) of the second user (18B) in the setup menu (54) (as shown in the example of FIG. 7). The first user (18A) by user command (44) in the setup menu (54) can select one or more functionalities (16) associated with the second computing device (8B) depicted in the list of functionalities (76). The setup module (53) can further function to allow the first computing device (8A) to remotely configure the second computing device (8B) of the second user (18B) to enable functionalities (16) selected in the list of functionalities (76) or function to allow the first computing device (8A) to remotely configure the one or more second computing devices (18B) to disable functionalities (16) that are not selected in the list of functionalities (76) depicted in the setup menu (54) displayed on the first computing device (8A). As further described below, one or more of the functionalities (16) of the second computing device (8B) can be enabled or disabled to provide an incentive (77) to the second user (18B) to modify performance of one or more target activities (30) toward one or more pre-selected target performance thresholds (78).

Now referring primarily to FIGS. 2 and 7, as to particular embodiments, the setup module (53) can further function to allow the first user (18A) to select or enter incentives (77) other than enabling or disabling the functionalities (16) of the second computing device (8B) used by the second user (18B). In this regard, the incentive (77) can, as illustrative examples, further include an increase or decrease in electronic credits (79) which can accrue and be converted or applied to one or more of: an amount of currency (80) (money in general use in a particular country); the purchase of goods or services in electronic commerce from on-line sites such as: i-Tunes®, Amazon®, and Alibaba®. Additionally, incentives (77) can further include an increase or decrease in the likelihood, frequency, or duration of consents (81) to certain events or conditions or occurrences such as amount of time with friends or watching television; later bedtime; access to snacks, or the like. As shown in the illustrative example of FIG. 7, the setup module (53) can generate a drop down list of incentives (82) in which the first user (18A) can interact to select one more incentive(s) (77) whether functionalities (16) of the second computing device (18B), electronic credits (79), or consents (81).

Again referring primarily to FIG. 7, as to particular embodiments, the setup module (53) can depict the incentives (77) as selectable lists of incentives (82) (whether functionalities (16), electronic credits (79) or consents (81)) correspondingly allocated in relation to one or more pre-selected target performance thresholds (78) which bound a corresponding one or more performance levels (83). As shown in the illustrative example of FIG. 7, a first performance threshold (78) can function to establish one performance level boundary (84A) between a first performance level (85A) (“level 1”) and second performance level (85B) (“level 2”). Also as shown in the illustrative example of FIG. 7, the setup module (53) can function to establish two performance level boundaries (84A) (84B) which correspondingly define three performance levels (85A)(85B)(85C) (shown in the example of FIG. 7 as: “level 1”, “level 2” and “level 3” respectively). The first user (18A) can by user command (44) in relation to each of three lists of incentives (82A)(82B)(82C) select one or more of the listed functionalities (16), listed electronic credits (79), or listed consents (81) to associate or disassociate with each of the three performance levels (85A)(85B)(85C) associated with the second user (18B) or a plurality of second users.

Again referring primarily to FIG. 7, as to particular embodiments, the setup module (53) can further function to depict an incentive confirmation icon (86) in the setup menu (54) associated with the selected list of incentives (82A)(82B)(82C). The first user (18A) by interaction with the incentive confirmation icon (86) can cause the setup module (53) to associate the list(s) of incentives (82A)(82B)(82C) selected by the first user (18A) with the user identifier (52A) of the second user (18B) and to save list(s) of incentives (82A)(82B)(82C) associated with the user identifier (52A) of the second user (18B) in the local memory (75) of the first computing device (8A) or in the server memory (4) of a server (2) within the system (1).

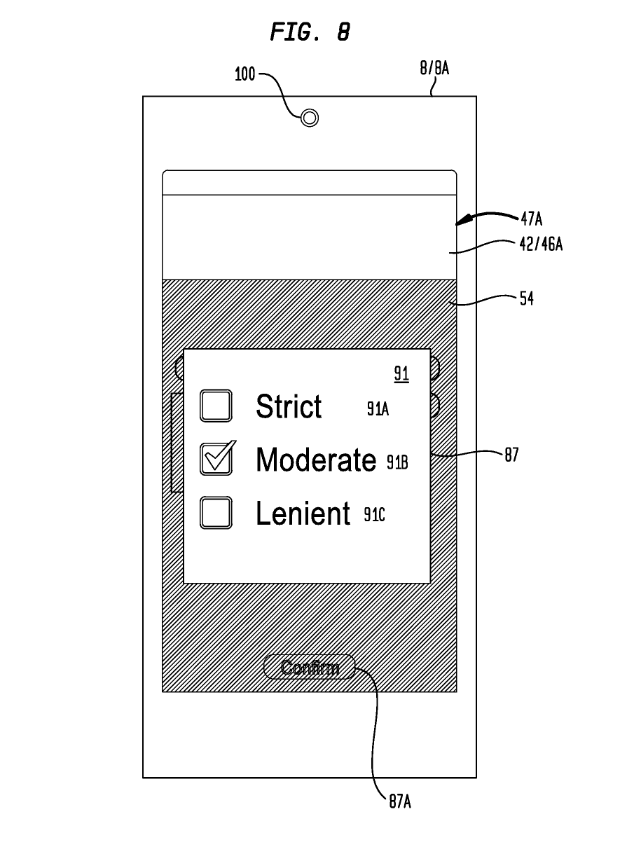

Now referring primarily to FIGS. 1, 2 and 8, as to particular embodiments the setup module (53) can further function to display in the setup menu (54) a score sensitivity selector (87) which by user command (44) of the first user (18A) allows entry of an indication of performance score sensitivity (91) by which the program applies a score sensitivity factor (88) to a performance score (89) associated with an indication of performance or non-performance (90A)(90B) of one or more target activities (30) by the second user (18B). As shown in the illustrative example of FIG. 8, the setup module (53) can function to depict a score sensitivity selector (87) allowing the first user (18A) to select by user command (44) one of three score sensitivity categories (91A)(91B)(91C) (score sensitivity category 1 (91A)—“strict”, score sensitivity category 2 (91B)—“moderate”, or score sensitivity category 3 (91C)—“lenient”). Each one of the score sensitivity categories (91A)(91B)(91C) can be associated with a performance score sensitivity factor (88) applied to a positive score (89A) obtained for an indication of performance (90A) of each of the one or more target activities (30) or be associated with a performance score sensitivity factor (88) applied to a negative score (89B) obtained for an indication of non-performance (90B) of each one of the one or more target activities (30) (or the pre-selected performance score factors (88) can be applied to both of the positive and negative scores (89A)(89B) obtained for an indication of performance or non-performance (90A)(90B) of each of the one or more target activities (30)).

In the illustrative example of FIG. 8, selection by the first user (18A) of score sensitivity category 1 (91A) (“strict”) prompts the program to apply a performance score factor (88) of 0.9 to each positive score (89A) of an indication of performance (90A) of each of the one or more target activities (30) and a performance score factor (88) of 1.1 can be applied to each negative score (89B) on an indication of non-performance (90B) of each of the one or more target activities (30). By first user (18A) selection of score sensitivity category 2 (91B) (“moderate”) the setup module (53) applies a performance score factor (88) of 1.0 to each positive score (89A) on an indication of performance (90A) of each of the one or more target activities (30) and applies a performance score factor (88) of 1.0 to each negative score (89B) on an indication of non-performance (90B) of each of the one or more target activities (30). By first user (18A) selection of score sensitivity category 3 (91C) (“lenient”) the setup module (53) applies a performance score factor of 1.1 to each positive score (89A) on an indication of performance (90A) of each of the one or more target activities (30) and applies a performance score factor (88) of 0.9 to each negative score (89B) on an indication of non-performance (90B) of each of the one or more target activities (30). This illustrative example of a score sensitivity selector (87) having three score sensitivity categories (91A)(91B)(91C) does not preclude embodiments having a lesser or greater number of score sensitivity categories (91) selectable by the first user (18A) in the setup menu (54) depicted in the graphical user interface (46) displayed on the first computing device (18A).

Embodiments of the computer program (29) having a setup menu (54) which depicts a sensitivity score selector (87) and correspondingly applies a performance score factor (88) to bias positive scores (89A) on an indication of performance (90A) of each of the one or more target activities (30) or to bias negative scores (89B) on indication of non-performance (90B) based on selected score sensitivity (91) may be independent of or in combination with embodiments of the computer program (29) which bias performance scores (89A)(89B) based on prior selected age status (55), development status (56), or clinical status (57) as further described below.

### The Login Module Second Computing Device.

Now referring primarily to FIGS. 1 and 2, as to particular embodiments, the log in module (51) can function to display the log in menu (52) on the second computing device display surface (47B) which by user command (44) the second user (18B) inputs the user identifier (52) associated with the data structures of the second user (18B) in the system (1). The log in module (51) can, but need not necessarily, further function to transmit pairing information (92) of the second computing device (8B) of the second user (18B) to the first computing device (8A) of the first user (18A) via network (9), such that the first computing device (8A) can be paired with the second computing device (8B) according to the pairing information (92) to establish wireless connection between the first computing device (8A) and the second computing device (8B). The computer program (29) can be executed to coordinate operation of the first computing device (8A) with the second computing device (8B).

Now referring primarily to FIGS. 1, 2, 9 and 10, as to particular embodiments, the user interface module (45) of the computer program (29) can further function to display a graphical user interface (46B) including a runtime menu (93) which by user command (44) of the second user (18B) executes the functions of a runtime module (94) which monitors indication of performance (90A) or indication of non-performance (90B) of the one or more target activities (30) by the second user (18B), attributes positive or negative scores (89A)(89B) and applies performance score factors (88) based on indication of performance (90A) or indication of non-performance (90B) of the one or more target activities (30), and can further function to allocate incentives (77) based upon performance score (89) in relation to one or more pre-selected target performance thresholds (78) which bound a corresponding one or more performance levels (83).

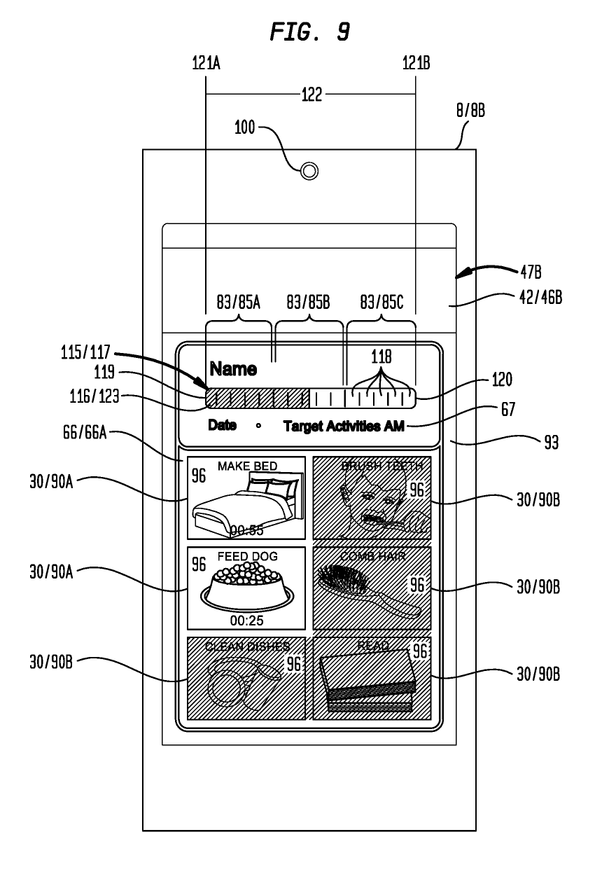

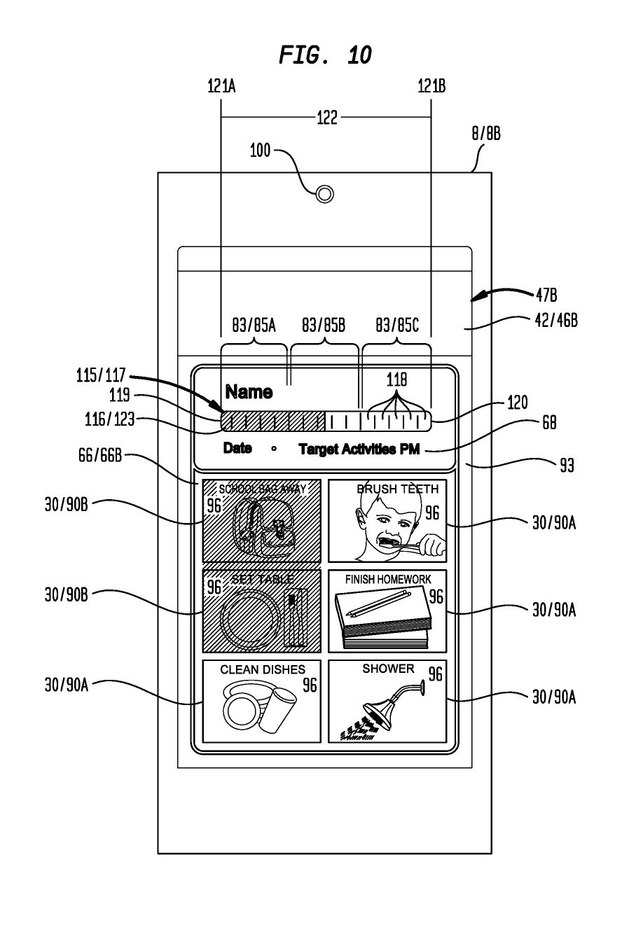

Now referring primarily to FIGS. 9 and 10, as to particular embodiments, the runtime module (94) functions to depict the list of one or more target activities (66) selected by the first user (18A) in the setup menu (54) in the runtime menu (93) of the second computing device (8B). Each of the one or more target activities (30) depicted in the runtime menu (93) on the second computing device (18B) can by user command (44) receive an indication of performance (90A) or an indication of non-performance (90B) (which may be generated by the runtime module (94) in the absence of a user command (44)). In some embodiments, the indication of performance (90A) can be generated by the runtime module (94) without second user (18B) user command (44), if the target activity (30) performed includes interacting with a functionality (16) of the second computing device (18), the GPS system (14), or an IOT (95), each of which may in coordination with runtime module (94) generate an indication of performance (90A) or an indication of non-performance (90B) of the one or more target activities (30) to the system (1).

Again referring primarily to the illustrative of FIGS. 9 and 10, the runtime menu (93) can further function to depict the one or more target activities (30) as discrete target activity images (96) which by interaction or non-interaction by the second user (18B) provides an indication of performance or non-performance (90A)(90B) of each of the one or more target activities (30) to the runtime module (94). As to particular embodiments, the discrete activity images (96) can, but need not necessarily, toggle between a target activity non-performance condition (96A) (shown in the example of FIGS. 9 and 10 as being illuminated) and a target activity performance condition (96B) (shown in the example of FIGS. 9 and 10 as being non-illuminated or a ghost image).

Again referring primarily to FIGS. 9 and 10, the runtime module (94) can, but need not necessarily, function to depict the list of target activities (30) in the runtime menu (93) of the second computing device (18B) as discrete lists of A.M. target activities (67) (before noon) and P.M target activities (68) (after noon). The runtime module (94) can, but need not necessarily, further include a timer module (97) which functions to time the depiction of the list of target activities (30) based on a pre-set start time (98A) and stop time (98B) of a time period (98) allocated by the runtime module (54) for an indication of performance or non-performance (90A)(90B) of the one or more target activities (30) depicted in the runtime menu (53). As an illustrative example, the runtime module (54) can function in association with the timer module (97) to depict in the runtime menu (53) A.M. target activities (67) between 12 Midnight until 12 Noon and depict P.M. target activities (68) between 12 Noon and 12 Midnight.

Again referring primarily to FIGS. 9 and 10, the second user (18B) upon performance of one or more of the target activities (30) depicted in the runtime menu (93) interacts by user command (44) in the runtime menu (93) to correspondingly provide an indication of performance (90A) or indication of non-performance (90B) of the one or more target activities (30).

Again referring to FIGS. 1, 2, 9 and 10, as to particular embodiments, the computer program can, can but need not necessarily, further include an image recognition module (99) which controls operation of an image capture element (100) which can be included in the second computing device (18B). The image capture element (100) can be operated by the image recognition module (99) by user command (44) to capture one or more target activity performance images (101) (whether as one discrete image, a plurality of discrete images, or a plurality of images in a video recording) representative of an indication of performance or non-performance (90A)(90B) of one or more target activities (30). The target activity performance image (101) can be inclusive of one image, or a plurality of images taken from a corresponding plurality of target activity performance views. As an illustrative example, the target activity (30) depicted in the runtime menu (93) of the second computing device (18B) can be “make the bed” and the image recognition module (99) can interact with the second user (18B) to take one or more target activity performance images (101) of the “bed” to allow the image recognition module (99) to differentiate between a “made bed” and an “unmade bed.” The image recognition module (99) can further function to compare each target activity performance image (101) to a plurality of target activity performance image templates (102) retrieved from a target activity performance image template database (103). The plurality of target activity performance image templates (103) can include one or more representations of a “made bed” and an “unmade bed.” A match between the target activity performance image (101) of a “made bed” and one of the plurality of target activity performance templates (102) representative of a “made bed” can serve as an indication of performance (90A) of the target activity (30) of “make bed”. The indication of performance or non-performance (90A)(90B) can be entered by operation of the image recognition module (99) without a discrete user command (44) in the runtime menu (53). The image recognition module (99) and operation of the image capture element (100) included in the second computing device (18B) can be utilized to provide an indication of performance or non-performance (90A)(90B) of numerous and varied target activities (30) in which indication of performance or non-performance (90A)(90B) can be recorded as one or more target activity performance images (101) and compared to a plurality of target activity performance image templates (102). As further illustrative examples, target activities (30) which can be assessed by the image recognition module (99) can include facial expressions, anatomical movements, action on an object to place the object in a pre-selected status or condition, or the like.

Again referring primarily to FIGS. 1, 9 and 10, embodiments can further include a GPS module (104) which operates to track location of the second computing device (18B) or one or more IOT devices (95) included in a list internet of things (105). For the purposes of this invention the term “IOT devices (95)” means physical devices embedded with electronics, software, sensors, actuators and public, cellular, or other network connectivity to collect and exchange data and without reduction in the breadth of the foregoing definition includes as illustrative examples: glucose meters, blood pressure meters, intravenous pumps, activity or fitness monitors, or tooth brushes. One or more target activities (30) associated with the GPS module (104) can be movement of the second user (18B) in regard to a time duration, a distance, or in relation to a place as represented by movement of the global positioning receiver (28) of second computing device (18B) or one or more IOT devices (95) trackable by the GPS (14). As one illustrative example, if one of the one or more target activities (30) includes movement of the second user (18B) as represented by movement of the global positioning receiver (28) of the second computing device (8B) to an expected location (38) at a future time (39), then indication of performance or non-performance (90A)(90B) of the target activity (30) of movement to an expected location (38) at the future time (39) can be determined by operation of the GPS module (104) in coordination with the timer module (97). A match or mismatch between the expected location (38) of the second computing device (18B) at the future time (39) and the actual location (35) of the second computing device (18B) at the expected time (39) can serve as an indication of performance or non-performance (90A)(90B). The indication of performance or non-performance (90A)(90B) can be entered by operation of the GPS module (104) without a discrete user command (44) in the runtime menu (53). The GPS module (104) can be operated to provide an indication of performance or non-performance (90A)(90B) of numerous and varied target activities (30) in which indication of performance or non-performance (90A)(90B) can be recorded due to movement in physical space. As further illustrative examples, target activities (30) can include an amount of distance traveled, location in relation to pre-selected boundaries, speed of travel, or rate of travel.

Again referring primarily to FIGS. 1, 9 and 10, embodiments can further include an IOT module (106) which operates to monitor the second user interaction with one or more IOT devices (95). The IOT module (106) can function to communicate with one or more the IOT devices (95) to collet IOT data (107) representative of performance or non-performance of one or more target activities (30). The IOT data (107) can be inclusive of any IOT sensed condition (108) which varies between an indication of performance and non-performance (90A)(90B) of one or more target activities (30), as illustrative examples: movement (including one or more of the GPS location, pitch, yaw, roll, tilt, vibration, jolt, impact), external temperature, physiological condition such as temperature, sound, heart rate, blood pressure, or blood glucose. As one illustrative, the IOT devices (95) can include a blood glucose meter (109) and the one or more target activities (30) can be performance of a glucose test (110) at an expected time (39). A match or mismatch between the actual performance of the glucose test (110) at the expected time (29) as received by the IOT module (106) of the second computing device (18B) can serve as an indication of performance or non-performance (90A)(90B) of the target activity (30). The indication of performance or non-performance (90A)(90B) can be entered by operation of the IOT module (106) without a discrete user command (44) in the runtime menu (54). The IOT module (106) can be operated to provide an indication of performance or non-performance (90A)(90B) of numerous and varied target activities (30) in which performance or non-performance can be reported due to a change in the IOT sensed condition (108). As further illustrative examples, target activities (30) which can be monitored by the IOT module (106) can, but need not necessarily include as illustrative examples: blood pressure measurement, heart rate measurement, glucose measurement, tooth brushing, or the like.

Now referring primarily to FIG. 1, embodiments of the computer program (29) can, but need not necessarily, further include a performance score module (111). The performance score module (111) receives the indication of performance (90A) or indication of non-performance (90B) of the one or more activities (30) in the runtime menu (53) of the second computing device (18B). The performance score module (111) can further function to calculate the target activity performance score (89) associated with the indication of performance or non-performance (90A)(90B) each of the one or more target activities (30) by the second user (18B).

TABLE 1
PERFORMANCE SCORE ALLOCATION

| | | Negative |
|---|---|---|
| Age Status Category (113) | Positive | Performance |
| Development Status Category (62) | Performance Score | Score |
| 3-6 years old (113A) | | |
| Below Grade Level (62C) | 460 | 200 |
| At Grade Level (62B) | 820 | 300 |
| Above Grade Level (62C) | 630 | 400 |
| 7-9 years old (113B) | | |
| Below Grade Level (62C) | 580 | 610 |
| At Grade Level (62B) | 720 | 750 |
| Above Grade Level (62C) | 1450 | 1360 |
| 10-14 years old (113C) | | |
| Below Grade Level (62C) | 430 | 1170 |
| At Grade Level (62B) | 525 | 720 |
| Above Grade Level (62C) | 300 | 880 |
| 15-18 years old (113D) | | |
| Below Grade Level (62C) | 620 | 500 |
| At Grade Level (62B) | 760 | 1215 |
| Above Grade Level (62C) | 820 | 1400 |

Now referring primarily to FIG. 1 and Table 1, as to particular embodiments, the performance score module (111) can function to attribute a positive score (89A) to each received indication of performance (90A) of one or more target activities (30) and to attribute a negative score (89B) to each received indication of non-performance (90B) of one or more target activities (30). Now referring to the illustrative example of Table 1, for a child having an “Age Status: 3 to 6 years old” and a “Development Status: Below Grade Level, the performance score module (111) can function to attribute a positive score (89A) of 460 to each received indication of performance (90A) of one or more target activities (30) and attribute a negative score (89B) of 200 to each received indication of non-performance (90B) of one or more target activities (30) and can further function to calculate a cumulative target activities performance score (112).

As to particular embodiments, the performance score module (111) can function to adjust the target activity performance score (89) attributable to each indication of performance or non-performance (90A)(90B) of one or more target activities (30) based on the age status (55) of the second user (18B) input by the first user (18A) in the setup menu (54) displayed on the first computing device (18A). Now referring to the illustrative example of Table 1, the performance score module (111) can adjust a positive score (89A) or a negative score (89B) (or both) based upon inclusion of the second user (18B) into one of a plurality of age status categories (113) (four discrete age status categories (113A)(113B)(113C)(113D) in the illustrative example: 3 years old to 6 years old; 7 years old to 9 years old; 10 years old to 14 years old; or 15 years old to 18 years old, respectively). As one example, the positive score (89A) attributed to performance of each of the one or more target activities (30) by a 5-year old is 820, and correspondingly, 760 when performed by a 15-year old. This illustrative example is not intended to preclude embodiments which omit score adjustment based on age status (55) or embodiments that have a greater or lesser discrete age status categories (113), or adjust the performance score (89) to a greater or lesser extent between age status categories (113).

As to particular embodiments, the performance score module (111) can further function to adjust the performance score (89) attributable to each indication of performance or non-performance (90A)(90B) of one or more target activities (30) based on a developmental status (56) of the second user (18B) selected by the first user (18A) in the setup menu (54) displayed on the first computing device (8A). Again referring to the illustrative example of Table 1, the performance score module (111) can function to adjusts the positive score (89A) or the negative score (89b) (or both) based upon inclusion of the second user (18B) into one of three discrete development status categories (62) (as show in the illustrative example of FIG. 4 “below grade level (62A)”; “at grade level (62B)” or “above grade level (62C)”). As one example, the positive score (89A) attributed to an indication of performance (90A) of each of the one or more target activities (30) by a 5-year old included in the development status category (62C) “below grade level” is 460, and correspondingly, 630 when performed by a 5-year old included in the development status category (62A) “above grade level”. This illustrative example is not intended to preclude embodiments which omit score adjustment based on development status (56) or embodiments that have a greater or lesser number of discrete development status categories (62), or adjust the performance score (89) to a greater or lesser extent between age status categories (113) or development status categories (62).

TABLE 2
PERFORMANCE SCORE SENSITIVITY FACTOR

| | Positive Performance | Negative Performance |
|---|---|---|
| Score Sensitivity | Score Factor | Score Factor |
| score sensitivity | 0.2 | 1.4 |
| category 1 | | |
| score sensitivity | .70 | .90 |
| category 2 | | |
| score sensitivity | 1.4 | .35 |
| category 3 | | |

Now referring primarily to FIG. 8 and Table 2, as to particular embodiments, the performance score module (111) can further function to adjust the performance score (89) attributed to the indication of performance or non-performance (90A)(90B) of one or more target activities (30) by the second user (18B) based on user's entered indication of score sensitivity level. Score sensitivity category (91) (shown in the example of FIG. 8—score sensitivity category 1 (91A)—“Strict”, score sensitivity category 2 (91B)—“Moderate”, or score sensitivity category 3 (91C)—“Lenient”) is selected by the first user (18A) in the set up menu (53) displayed on the first computing device (18A). The performance score module (111) can function to apply a performance score factor (88) to both of the positive and negative performance scores (89A)(89B) in response to an indication of performance or non-performance (90A)(90B) of each of the one or more target activities (30) based on the selected score sensitivity category (91).

Now referring primarily to FIG. 1, as to particular embodiments, the computer program (29) can further include a performance score comparator (114) executable to compare the indication of performance or nonperformance (90A)(90B) of the one or more target activities (30) by the second user (18B) to a corresponding one more target performance thresholds (78) of performance of the one or more target activities (30). The one or more target performance thresholds (78) can bound a corresponding one or more performance levels (83). In the illustrative example above described the setup module (54) can establish two pre-selected boundaries (84A)(84B) which correspondingly define three performance levels (85A)(85B)(85C) (shown in the example of FIG. 7 as: “level 1”, “level 2” and “level 3” respectively).

Again referring primarily to FIGS. 9 and 10, the graphic user interface module (54) can, but need not necessarily, function to display a performance status indicator (115) on the display surface (47B) of the second computing device (18B) to provide sensorially perceivable indicia (116) in proportion to the cumulative performance score (112) calculated by the performance score module (111). The sensorially perceivable indicia (116) can be continuously or intermittently variably adjusted based on the cumulative target activities performance score (112) in relation to the one or more boundaries (84) defined by the pre-selected target performance thresholds (78) represented by the performance levels (83) depicted in the setup menu (54). As to a particular embodiments, the graphical user interface module (54) can, but need not necessarily, depict a performance status indicator (115) in the form of a graduated graphic bar scale (117) visually demarcated to represent the performance levels (83) depicted in the setup menu (54) (as shown in the examples of FIGS. 9 and 10 there performance levels (85A)(85B)(85C)) based on the pre-selected target performance thresholds (78) of performance of the one or more target activities (30). Each of the plurality of performance levels (83), can, but need not necessarily, be sub-demarcated into a plurality of performance sublevels (118) (as shown in the examples of FIGS. 9 and 10 five performance sublevels). As to particular embodiments, the graduated graphic bar scale (117) can, but need not necessarily, have an open bar scale field disposed between a first terminal end (119) and a second terminal end (120) of the graduated graphic bar scale (117) establishing first and second end points (121A)(121B) of a scoring range (122). The illustrative example of an performance level indicator (115) depicted as a graduated graphic bar scale (117), is not intended to preclude other forms of graphical depiction of the performance level indicator (115) which for example could be depicted as a plurality of concentric circles representing the scoring range from zero at the center point representing the cumulative score at which all of the one more target activities (30) have been performed at the circumference of the circle, or in another alternative, by transit of an indictor between first and second end points (121A)(121B), or the like.

The scoring range (122) between the first and second end points (121A)(121B) can represent a cumulative performance score (112) at the first end point (121A) representing that none of the one or more target activities (30) have been performed by the second user (18B) up to a cumulative performance score (112) at the second end point (121B) which represents that all of the one or more target activities (30) have been achieved by the second user (18B). Depending on the number of target activities (30) and the target activity performance score (89) attributable to the indication of performance or non-performance (90A)(90B) of the one or more target activities (39), the scoring range (122) represented by the graduated graphic bar scale (117) can be lesser or greater between first and second end points (121A)(121B). In regard to the illustrative example shown by FIGS. 9 and 10, the graduated graphic bar scale (117) demarcates three performance levels (85A)(85B)(85C) with each of the three performance levels (85A)(85B)(85C) sub-demarcated into five performance sub-levels (118). The scoring range (122) between first and second end points (121A)(121B) can, but need not necessarily, be between zero and 15,000 with each of the three performance levels (85A)(85B)(85C) defined by a boundaries (84) established at a score of: 0 (first end point (121A)), 5000, 10,000, and 15,000 (second end point (121B)). Each of the five performance sublevels (118) in each of the three performance levels (85A)(85B)(85C) can represent a cumulative performance score of 1000.

Again referring primarily to FIGS. 9 and 10, as to particular embodiments, the performance score comparator (114) can further function to continuously or periodically adjust the performance status indicator (115) to provide a sensorially perceivable indicia (116) (such as graphic indicia, light indicia, sound indicia, tactile indicia, or the like, or combinations thereof) which variably proportionately change based on the cumulative performance score (117) calculated by the performance score module (111) and compared by the performance score comparator (114) to the pre-selected target performance thresholds (78) which define the one more performance levels (83) represented by the performance status indicator (115). In the illustrative example, the sensorially perceivable indicia (116) comprises a bar (123) which variably adjustably fills the graduated graphic bar scale (117) from the first end point (121A) toward the second end point (121B) of the scoring range (122) based on the cumulative performance score (117) attributable to the indication of performance or non-performance (90A)(90B) of the one or more target activities (30). Likewise, indication of non-performance can variably adjustably empty the graduated graphic bar scale (117) from the second end point (121B) toward the first end point (121A).

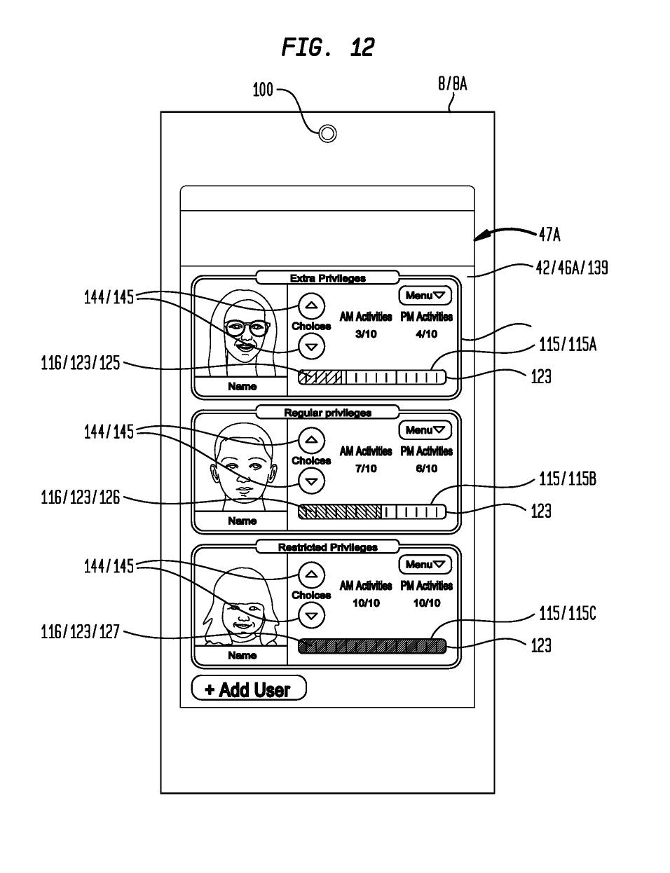

Now referring primarily to FIG. 12, as to particular embodiments, more than one sensorially perceivable indicia (116) which variably proportionately changes based on the cumulative performance score (112) can be utilized in provision of the performance status indicator (115). As one example, the sensorially perceivable indicia (116) can, but need not necessarily, include the bar (123) which variable adjusts between the first and second end points (121A)(121B) of the scoring range (122) and can further include a change in color corresponding to change in performance level (83), for example, a red color (125) for a first performance level (85A), a yellow color (126) for a second performance level (85B) and a green color (127) for a third performance level (85C).

Again primarily referring to FIGS. 9 and 10, as an illustrative example, the runtime module (94), in coordination with performance score module (111) and the performance score comparator (114) can initially establish the cumulative performance score (112) and the corresponding representation of the sensorially perceivable indicia (116) within the performance status indicator (115) at the midpoint (127) of the scoring range (122). Thereafter, the runtime module (94) in coordination with performance score module (111) can sum the positive scores (89A) or negative scores (89B) (as shown in the illustrative example of Table 1) to adjust the cumulative score (112) above or below the midpoint (127) in the scoring range (122). Correspondingly, the runtime module (111) in coordination with the performance score comparator (114) can compare the cumulative performance score (112) to the one or more pre-selected thresholds of performance (83) and continuously or intermittently adjust the sensorially perceivable indicia (116) within the performance status indicator (115) to represent indication of performance or non-performance (90A)(90B) of the one or more target activities (30) by the second user (18B).

As to particular embodiments, the performance score module (111) in coordination with the performance score comparator (114) and timer module (97) can, but need not necessarily, further function to adjust the target activity performance score (89) attributable to indication of performance or non-performance (90A)(90B) of one or more target activities (30) based on prior indication of performance or non-performance (90A)(90B) of one or more target activities (30) over a time period (98). The performance score comparator (114) can further function to calculate an elapsed time (128) that a cumulative performance score (112) resides in a particular performance level (83) (also referred to as a “performance level time interval (129)”). The performance score comparator (114) can further function to compare the performance level time interval (129) to one or more pre-selected performance level time interval thresholds (130). Upon occurrence of a performance level time interval (129) that meets or exceeds a performance level time interval threshold (130), the performance score module (111) can alter the pre-selected performance score factor (88) applied to the positive score (89A) for an indication of performance (90A) of each of the one or more target activities (30) or applied to the negative score (89B) for an indication of non-performance (90B) of each of the one or more activities (30).

As an illustrative example, in the event that the cumulative performance score (112) resides in performance level 1 (35A) (a cumulative performance score (112) of equal to or less than 5,000) for an interval of 10 hours, then the performance score comparator (114) can cause the performance score module (111) to alter the pre-selected performance score factor (88) applied to the positive score (89A) for an indication of performance (90A) of each of the one or more target activities (30) to 3.0 and without change to the pre-selected performance score factor (88) applied to the negative score (89A) for an indication of non-performance (90A) of each of the one or more activities (30). In the event that the cumulative performance score (112) continues to reside in performance level 1 (35A) for an interval of 20 hours, then the performance score comparator (114) can cause the performance score module (111) to alter the pre-selected performance score factor (88) applied to the positive score (89A) for an indication of performance (90A) of each of the one or more target activities (30) to 5.0 and without change to the pre-selected performance score factor (88) applied to the negative score (89B) for an indication of non-performance (90B) of each of the one or more activities (30). The illustrative examples described are not intended to preclude embodiments which alter the pre-selected performance score factor (88) applied to the positive score (89A) or to the negative performance score (89B) to a greater or lesser extent depending on the application. The advantage in affording and then altering the pre-selected performance score factor (88) applied to the positive or negative score (89A)(89B), in various combinations and permutations, based on prior indication of performance or non-performance (90A)(90b) of the one or more target activities (30), can be that the runtime module (94) may be continuously or periodically operably reconfigured to allocate cumulative performance scores (112) that bias performance of the one or more target activities (30) by the second user (18B) toward an indication of performance (90A) over indication of non-performance (90B).

Additionally, as to particular embodiments, the performance score module (111) in coordination with the performance score comparator (114) and timer module (97) can further function to add or remove target activities (30) allocated to the runtime module (94) in the second computing device (18B) based on prior indication of performance or non-performance (90A)(90B) of one or more target activities (30) over a period of time (128). As an illustrative example, in the event that the cumulative performance score (112) resides in performance level 3 (85C) for an interval of 30 hours, then the performance score comparator (114) can further cause the run module (94) to alter the list of target activities (30) by adding one or more target activities (30) from unassigned target activities (131) stored in the system (1). Similarly, in the event that the cumulative performance score (112) resides in performance level 1 (85A) for an interval of 50 hours, then the performance score comparator (114) can further cause the run module (94) to alter the list of target activities (30) by removing one or more target activities (30) from the list of target activities (66) to the unassigned target activities (131) stored in the system (1).

As to particular embodiments, the performance score comparator (114) can further function to compare indication of performance (90A) of each one of the one or more target activities (30) against opportunities to indicate performance (132) of each one of the one or more target activities (30). Based upon performance of one of the target activities (30) over opportunities to indicate performance (132) (which can, but need not necessarily, be consecutive opportunities to indicate performance) of one target activity (30), the performance score comparator (114) can cause the performance score module (94) to alter the pre-selected performance score sensitivity factor (88) applied to the positive score (89A) or the negative performance score (89B) for that one target activity (30) or cause the runtime module (94) to replace that one target activity (30) with an unassigned target activities (131) or remove that one target activity (30) from list of one or more target activities (66) depicted by the runtime module (94) on the second computing device (18B), or a combinations thereof.

As an illustrative example, where the second user (18B) indicates performance (90A) of one of the target activities (30) 230 times out of 240 opportunities to indicate performance (132) of that one target activity (30) the performance score comparator (114) can recommend to the first user (18A) or cause that one target activity (30) to be replaced by another target activity (30) from unassigned target activities (131). As a further illustrative example, where the second user (18B) indicates non-performance (90B) of one of the one or more target activities (30) 12 times out of 12 consecutive opportunities to indicate performance (132) of one of the one or more target activities (30), then the performance score comparator (114) can cause the performance score module (94) to alter the pre-selected performance score factor (88) applied to the positive performance score (89A) to 2.75 without adjustment to the pre-selected performance score factor (88) applied to the negative performance score (89B).

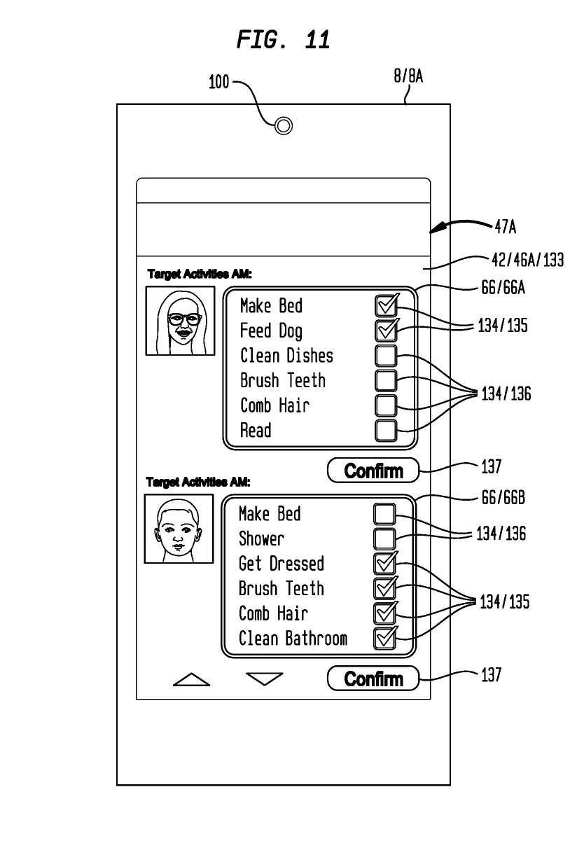

Now referring primarily to FIGS. 1, 2 and 11 through 13, as to particular embodiments, the runtime module (94) can periodically interrogate the one or more second computing devices (8B) of the one or more second users (18B) to report indication of performance (90A) or indication of non-performance (90B) of the one or more target activities (30) associated with each one of the one or more second computing devices (18B) to the first computing device (18A). As shown in the illustrative example of FIG. 11, the runtime module (94) and in coordination with the user interface module (45) can intermittently or continuously depict a target activity performance menu (133) on the display surface (47A) of the first computing device (18B). The target activity performance menu (133) depicts the list of target activities (66) associated with each of the one or more second computing devices (18B) along with the target activity performance indicator (134) associated with each one or more target activities (30). A target activity performance indicia (135) (as shown in the example of FIG. 11, can be a box filled with a check mark) can be associated with one of the target activities (30) represents an indication of performance (90A) of that target activity (30) by the second user (18B). A target activity non-performance indicia (136) associated with one of the target activities (30) represents an indication of non-performance (90B) of that target activity (30) (as one example an absence of a check mark in a box).

Again referring to FIG. 11, as to particular embodiments, the target activity performance menu (133) can, but need not necessarily, include a target activity validation icon (137) discretely associated with each one of the one more lists of target activities (66) correspondingly associated with each of the one or more second computing devices (18B). The target activity validation icon (137) can by user command (44) confirm or validate the accuracy as to the reported indication of performance (90A) or reported indication of non-performance (90B) of the one or more listed target activities (30) by the second user (18B).

Again referring to FIG. 1, as to particular embodiments, the computer program (29) can, but need not necessarily, include an incentive allocation module (138). The incentive allocation module (138) can, but need not necessarily, be activated by the first user (18A) interaction with the target activity validation icon (137) in the target activity performance menu (133). The incentive allocation module (138) functions to allocate the incentives (77) selected by the first user (18A) by interaction in the setup menu (54) (whether functionalities (16) of the second computing device (18B), electronic credits (79), or consents (81)) to the second computing device (18B) based on performance or non-performance (90A)(90B) of one or more target activities (30) by the second user (18B) in relation to one or more pre-selected target performance thresholds (78) which bound a corresponding one or more performance levels (83), as above described. The incentive allocation module (138) can function to affirmatively block the functionalities (16) of the second computing device (18B) which are not allocated to a particular performance level (83). As shown in the illustrative example of FIG. 7, the setup menu (54) depicted does not allocate any functionalities (16) of the second computing device (18B) to performance level 1 (85A) and further functions to block implementation of those functionalities (16) in the second computing device (18B) for as long as indication of performance (90A) resides in performance level 1 (85A). Additionally, the incentives allocation module (138) can further function to unblock and allow implementation of those functionalities (16) in the second computing device (18B) selected by the first user (18A) in the setup menu (54) in each of performance level 2 (85B) and performance level 3 (85C) as indication of performance (90A) correspondingly resides in performance level 2 (85B) or performance level 3 (85C).

Now referring primarily to FIGS. 1, 2 and 12, the runtime module (94) in coordination with the user interface module (45) can, but need not necessarily, function to depict on the display surface (47A) of the first computing device (18A) a performance level status menu (139) which for each second computing device (18B) paired with the first computing device (18A) correspondingly depicts a representation of the performance level status indictor (115) displayed on each second computing devices (18B). As shown in the illustrative example of FIG. 12, the first computing device (18A) has been paired with three other computing devices (18B) and the runtime module (94) functions to depict each of the three performance level status indicators (115A)(115B)(115C) corresponding to each of the three second computing devices (18B) in the performance level status menu (139). As to particular embodiments, the runtime module (94) can further depict on the display surface (47A) of the first computing device (18A) a target activity performance score adjustment elements (144) which by user command (44) can cause the performance score module (111) to increase or decrease the target activity performance scores (89) attributable to the indications of performance (90A) or indications of non-performance (90B) by the second user (18B). The illustrative example shown in FIG. 12, depicts the target activity performance score adjustment elements (144) as a pair of a target activity performance score adjustment icons (145), a first of which can by interaction with the first user (18A) and by operation of the performance score module (111) increase the target activity performance score (89) and a second of which can by interaction with the first user (18A) decrease the target activity performance score (89).

Now referring primarily to FIGS. 1, 2 and 13, embodiments of the program (29) can, but need not necessarily, include an editing module (140) which functions in coordination with the user interface module (45) to depict an edit menu (141) on the display surface (47A) of the first computing device (8A). The first user (18A) by user command (44) can enter the user identifier (52) of the second user (18B) to obtain access to the data structures associated with the second computing device (8B) of the second user (18B) associated with the entered user identifier (52). The edit menu (141) can further function to depict the drop down lists (59)(62)(63) associated with the age status (55), development status (56) and clinical status (57) associated with the second computing device (18B) which by user command (44) can be updated with current age indicia (60), development status category (62), or clinical status indicia (64) respectively. The edit menu (141) can further function to depict the drop down list of one or more target activities (66) associated with the second computing device (18B) (as shown in the example of FIGS. 5 and 6) which by user command (44) can be updated to add, remove, or replace one or more of the target activities (30) (whether A.M target activities (67) or P.M. target activities (68)). The edit menu (141) can further function to depict the drop down list of incentives (82) associated with the second computing device (18B) (as shown in the example of FIG. 7) which by user command (44) can be updated to add, remove, or replace one or more of the incentives (77) (whether functionalities (16), electronic credits (79), or consents (81)).

Again referring primarily to FIGS. 1, 2 and 13, the program (29) can, but need not necessarily include, a guidance module (142) coordinated with the runtime module (94) and the edit module (140) which based on indications of performance (90A) or indications non-performance (90B) over elapsed time (128) functions to match indications of performance or non-performance to customized information (146) in a database (142) and depict the customized information (146) to assist the first user (18A) in allocating incentives or otherwise interacting with the second user (18B).

As to particular embodiments, the customized information (146) can in part provide information related to operation of the first or second computing devices (18A)(18B) and user commands (44) in the graphical user interface (42) to activate the functions of computer program (29). As an illustrative example, the customized information (146) can in part include guidance to the first user (18A) on the use of the target activity performance score adjustment elements (144) based on indications of performance (90A) or indications of non-performance (90B) of one or more target activities (30) by the second user (18B) or based on first user (18A) direct observation of performance or non-performance of one or more target activities (30 by the second user (18B). As to particular embodiments, the edit module (140) can, but need not necessarily, function to depict an alert icon (147) which by user command (44) causes the edit module (140) to depict an instruction to monitor indications of performance (90A) and indications of non-performance (90B) or directly observe the performance or non-performance of target activities (30) by the second user (18B) and further instruct the first user (18A) to use the target activity performance score adjustment elements (144) to increase or decrease target activity performance scores (89) based upon the first user (18A) observations of performance or non-performance of target activities (30) by the second user (18B).

As can be easily understood from the foregoing, the basic concepts of the present invention may be embodied in a variety of ways. The invention involves numerous and varied embodiments of an activity enhancement performance system and methods for making and using such activity enhancement performance system including the best mode.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “score sensitivity selector” should be understood to encompass disclosure of the act of “selecting a score sensitivity”—whether explicitly discussed or not—and, conversely, were there effectively disclosure of the act of “selecting a score sensitivity”, such a disclosure should be understood to encompass disclosure of a “score sensitivity selector” and even a “means for selecting score sensitivity.” Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) each of the activity enhancement performance system herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A computer implemented system, comprising:
a memory element containing a program;
a processor communicatively coupled to said memory element, said program executable by said processor to:
depict a plurality of target activities in a user interface of a computing device;
receive an indication of performance or non-performance of each of said plurality of target activities;
compare said indication of performance or non-performance of said plurality of target activities to corresponding pre-selected target activity performance thresholds; and
allocate incentives based upon comparison of said performance or non-performance of said plurality of target activities to said pre-selected target activity performance thresholds.

2-29. (canceled)

30. The system of claim 1, wherein said computing device comprises a first computing device and a second computing device, and

31. The system of claim 30, wherein said program is further executable to depict a setup menu in said user interface of said first computing device in which a first user can select one or more of an age status, a developmental status, or a clinical status of a second user of said second computing device.

32. The system of claim 31, wherein said program is further executable to:
depict in said setup menu in said user interface of said first computing device a list of target activities based upon one or more of said age status, said development status, or said clinical status of said second user of said second computing device; and
generate said plurality of target activities based upon target activities selected by said first user of said first device from said list of target activities.

33. The system of claim 32, where said program is further executable to modify said list of target activities based upon one or more target activities entered by user command of said user into said setup menu.

34. The system of claim 33, wherein said program is further executable to:
depict in said setup menu a list of incentives in said user interface of said first computing device; and
allocate said incentives based on incentives selected by said first user of said first device from said list of incentives.

35. The system of claim 34, where said program is further executable to modify said list of incentives based upon one or more incentives entered by user command of said user into said setup menu.

36. The system of claim 35, wherein said program is further executable to:
pair said first computing device with said second computing device interrogate said second computing device to inventory functionalities of said second computing device;
depict said functionalities of said second computing device in said list of incentives in said user interface of said first computing device; and
enable or disable functionalities of said second computing device based upon incentives selected by said first user of said first device.

37. The system of claim 36, wherein said program is further executable to:
depict in said setup menu in said first user interface said plurality of performance levels each discretely associated with said list of incentives;
allocate said incentives discretely associated with each performance level based upon said incentives selected by said first user of said first device from said list of incentives associated with each of said performance levels.

38. The system of claim 37, wherein said program is further executable to:
depict in said setup menu in said user interface of said first computing device a score sensitivity selector in which a first user can select indications that prompt program to adjust score sensitivity level; and
generate a performance score sensitivity factor based upon said score sensitivity level selected by said first user of said first device.

39. The system of claim 38, wherein said program is further executable to:
pair said first computing device with said second computing device; and
depict said plurality of target activities in said user interface of said second computing device based upon selected target activities in said user interface of said first computing device.

40. The system of claim 39, wherein said program is further executable to receive said indication of performance or non-performance of each of said plurality of target activities in said user interface of said second computing device.

41. The system of claim 40, wherein said program is further executable to allocate incentives based upon comparison of said indication of performance or non-performance of said plurality of target activities in said user interface of said second computing device to corresponding said pre-selected target activity performance thresholds.

42. The system of claim 41, wherein said program is further executable to report indication of performance or non-performance of each of said plurality of target activities in said user interface of said second computing device to said first computing device.

43. The system of claim 42, wherein said program is further executable to:
receive validation in said first user interface to said indication of performance or non-performance of each of said plurality of target activities in said user interface of said second computing device; and
allocate incentives subsequent to receiving validation in said first user interface of said first computing device.

44. The system of claim 43, wherein said program is further executable to depict in said user interface of said first computing device a representation of the performance level status indictor depicted in said user interface of said second computing device.
